(19) United States
(12) Patent Application Publication
(10) Pub. No.: US 2018/0238643 A1
(43) Pub. Date: Aug. 23, 2018

(54) OUTDOOR PLATE-TYPE VACUUM HEAT TRANSFER APPARATUS

(71) Applicants: IBT Co., Ltd., Gwangju (KR); SAMSUNG ELECTRONICS CO., LTD., Gyeonggo-do (KR)

(72) Inventors: Sang Koo Park, Siheung-si (KR); Jin Hyun Cho, Seoul (KR)

(21) Appl. No.: 15/437,231

(22) Filed: Feb. 20, 2017

(51) Int. Cl. F28F 9/26; F28F 3/00; B23P 15/26

(52) U.S. Cl. CPC F28F 9/26; B23P 15/26; F28F 3/00

(57) ABSTRACT

Disclosed herein is an outdoor plate-type vacuum heat transfer apparatus. This apparatus is configured by sequentially layering an inorganic sheet 320, a mesh member 330, and a support frame 340 in a slim internal space of a plate-type container defined by first and second plates 310 and 350. A small amount of heat transfer medium is inserted into the internal space in a vacuum state.

### BACKGROUND OF THE INVENTION

### 1. Field of the Invention

The present invention relates to an outdoor plate-type vacuum heat transfer apparatus. More particularly, the present invention relates to an outdoor plate-type vacuum heat transfer apparatus, which has a vacuum therein and is attached to an outdoor display device, thus preventing a product from malfunctioning or being damaged or broken due to heat generation.

### 2. Description of the Related Art

A conventional heat pipe is divided into an evaporation part (heat absorbing part) that obtains heat and a condensation part (heat emitting part) that emits heat, and has a vacuum therein, so that it transfers heat at a rate that is about 1,000 times higher than copper, which has high heat conductivity. Thus, the heat pipe is attached to a CPU, a graphic card or the like of a computer that generates high temperature heat.

However, such a heat pipe is problematic in that the areas of the heat absorbing part and the condensation part are small because of the mechanical properties thereof, so that it is difficult to deal with a product having a large heat generating area or a product generating high temperature heat. Consequently, an additional device such as a heat sink or a fan is required. Further, the heat pipe is operated in a natural circulating system using gravity. Here, if a heating element has the same height as the condensation part or the heating element is installed relative to the condensation part at the angle of 15° or less, performance may be considerably deteriorated and thereby the heat pipe may frequently malfunction.

As illustrated in FIGS. 1 to 3, a conventional heat pipe 100 is made of metal such as copper or aluminum having high heat conductivity and is composed of a container 110 having the shape of a cylindrical rod. A sintered, meshed or grooved wick 120 is provided on an inner wall of the heat pipe 100, a heat transfer medium is injected into an empty space thereof, and a vacuum is created in the heat pipe.

The conventional heat pipe 100 has the structure of the cylindrical rod to ensure fast evaporation and condensation and thereby increase a heat transfer rate. However, although the structure of the cylindrical rod ensures fast evaporation and condensation, it has a small contact surface, so that its application is limited to a small-sized product, such as a CPU or a graphic card of a computer, and the positions of the evaporation part and the condensation part are fixed, so that the designing of a device is limited. Further, since the heat pipe is made of copper or aluminum so as to increase heat conductivity, rigidity is relatively low and it is difficult to handle and manufacture.

Korean Patent No. 10-0775013 has proposed a “Plate-type heat transfer apparatus”, which is shown in FIG. 4. The plate-type heat transfer apparatus 200 includes: first and second plates 210 and 220 that define a sealed internal space; a refrigerant that is injected into an internal space; a capillary wick 230 that is in close contact with at least one of the first and second plates 210 and 220 in the internal space to absorb liquid-phase refrigerant; and a hole structure 240 having bent parts 241 and holes 242. The bent parts 241 are formed by cutting and bending predetermined portions of the hole structure to define a space, thus allowing gas-phase refrigerant to smoothly pass between the first and second plates 210 and 220, and support the capillary wick 230. The holes 242 are formed in portions that are cut to form the bent parts 241, so that gas-phase refrigerant vaporized in the capillary wick 230 passes therethrough.

Therefore, an advantage of the related art is that the entire structure is simple, and the refrigerant flows smoothly, thus providing good cooling efficiency. However, the related art is problematic in that the interior does not maintain a vacuum state, so that it is impossible to manufacture and apply the heat pipe in a large area. Further, the hole structure 240 is configured to have the bent parts 241 and the holes 242 considering only the smooth passing of the gas-phase refrigerant, so that a horizontal configuration is possible but a vertical configuration is impossible. Furthermore, this has a drawback in that a specific configuration for applying the related art to an actual product is not considered.

The foregoing is intended merely to aid in the understanding of the background of the present invention, and is not intended to mean that the present invention falls within the purview of the related art that is already known to those skilled in the art.

### RELATED ART DOCUMENT

### Patent Document

(Patent 1) Korean Patent No. 10-0775013

### SUMMARY OF THE INVENTION

Accordingly, the present invention has been made keeping in mind the above problems occurring in the related art, and an object of the present invention is to provide an outdoor plate-type vacuum heat transfer apparatus, in which a vacuum is created in a plate-type container made of a plate and a sheet is placed in the container, so that evaporation and condensation of a heat transfer medium may occur on all sides of the container, and consequently areas of an evaporation part and a condensation part are increased, a location of a heat source is freely set, and a vertical configuration is possible.

Another object of the present invention is to provide an outdoor plate-type vacuum heat transfer apparatus, which allows an LED module and a light guide plate constituting an outdoor display device to be more ideally combined with each other by designing the shape of a plate constituting a plate-type container.

In order to accomplish the above objects, the present invention provides an outdoor plate-type vacuum heat transfer apparatus including a plurality of plate-type vacuum heat transfer apparatuses that are assembled to be integrated with each other, the plate-type vacuum heat transfer apparatus including a first plate and a second plate sealed to define an internal space in a vacuum state, a heat transfer medium supplied to a portion of the internal space, an inorganic sheet provided such that a first surface thereof is in close contact with an inner surface of the first plate in the internal space, a mesh member coming into close contact with a second surface of the inorganic sheet, and a support frame provided such that both surfaces thereof are in close contact with inner surfaces of the mesh member and the second plate, respectively, and defining a flow passage of the heat transfer medium, wherein the first plate includes a welding part formed along an edge and welded to the second plate, an LED module-mounting part provided to form a step of a predetermined height with the welding part, thus defining an LED-module mounting surface, and a light guide plate-mounting part provided to form a step of a predetermined height with the LED module-mounting part, thus defining a light guide plate-mounting surface.

The LED module-mounting part may further include a plurality of depression preventing recesses formed at equal intervals.

The LED module-mounting part may further include a plurality of fastening nuts installed at equal intervals to fasten the LED module.

The LED module-mounting part may further include a plurality of fastening pins to fasten a light guide plate.

The LED module-mounting part may further include a plurality of connection-terminal mounting recesses used to connect with the LED module.

The support frame may be made by bending a perforated plate.

The inorganic sheet may further include a plurality of holes.

The second plate may further include on an outer surface thereof a plurality of brackets to install a closing cover.

Three plate-type vacuum heat transfer apparatuses may be assembled and integrated with each other using a separate bracket to have a size corresponding to a display area of 75 inches.

As described above, the present invention provides an outdoor plate-type vacuum heat transfer apparatus, in which a vacuum is created in a plate-type container made of a plate and a sheet is placed in the container, so that evaporation and condensation of a heat transfer medium may occur on all sides of the container, and consequently areas of an evaporation part and a condensation part are increased, a location of a heat source is freely set, and a vertical configuration is possible.

Further, the present invention provides an outdoor plate-type vacuum heat transfer apparatus, which allows an LED module and a light guide plate constituting an outdoor display device to be more ideally combined with each other by designing the shape of a plate constituting a plate-type container.

### BRIEF DESCRIPTION OF THE DRAWINGS

The above and other objects, features and advantages of the present invention will be more clearly understood from the following detailed description taken in conjunction with the accompanying drawings, in which:

FIGS. 1 to 3 are a plan view and sectional views illustrating the configuration of a conventional heat pipe;

FIG. 4 is an exploded perspective view illustrating the configuration of a conventional plate-type heat transfer apparatus;

FIG. 5 is a plan view illustrating the configuration of an outdoor plate-type vacuum heat transfer apparatus according to an embodiment of the present invention;

FIG. 6 is a perspective view illustrating the assembled state of the plate-type vacuum heat transfer apparatus of FIG. 5;

FIG. 7 is an enlarged sectional view taken along line C-C of the plate-type vacuum heat transfer apparatus of FIG. 6;

FIG. 8 is a plan view illustrating a first plate of FIG. 6;

FIG. 9 is a plan view illustrating an inorganic sheet of FIG. 7;

FIG. 10 is a plan view illustrating a second plate when a support frame of FIG. 7 is arranged; and

FIG. 11 is a rear view illustrating the second plate of FIG. 7.

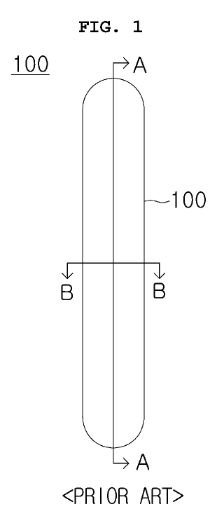

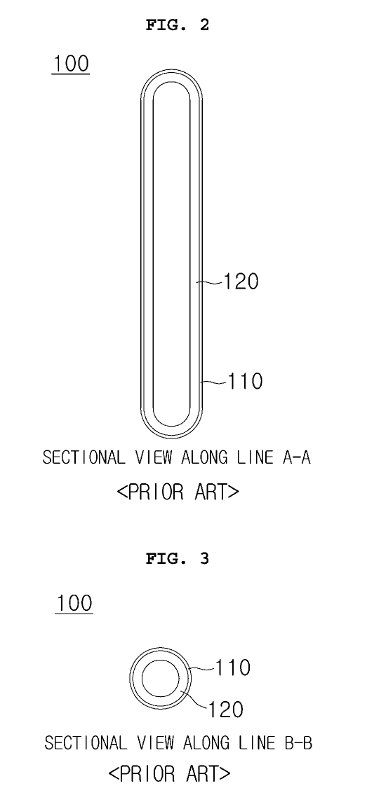

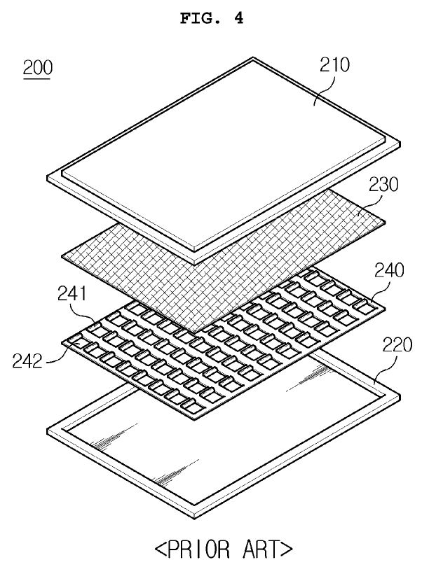

### DESCRIPTION OF PREFERRED EMBODIMENTS

Hereinafter, a preferred embodiment of an outdoor plate-type vacuum heat transfer apparatus according to the present invention will be described in detail with reference to the accompanying drawings.

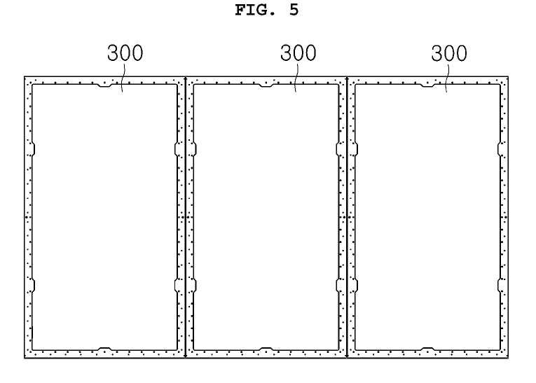

FIG. 5 is a plan view illustrating the configuration of an outdoor plate-type vacuum heat transfer apparatus according to an embodiment of the present invention. As illustrated in FIG. 5, the outdoor plate-type vacuum heat transfer apparatus of this embodiment is composed of a plurality of plate-type vacuum heat transfer apparatuses 300 that are assembled to be integrated with each other. In this embodiment, the outdoor plate-type vacuum heat transfer apparatus is composed of three plate-type vacuum heat transfer apparatuses 300.

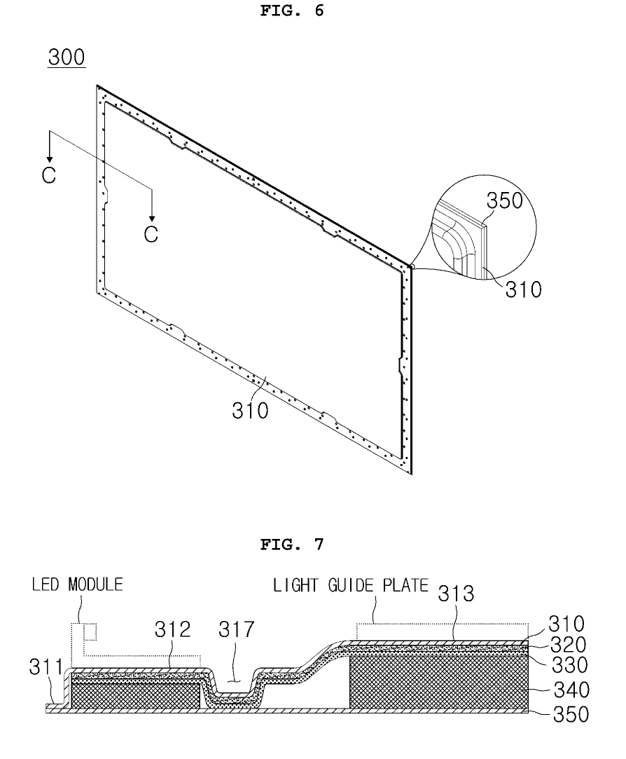

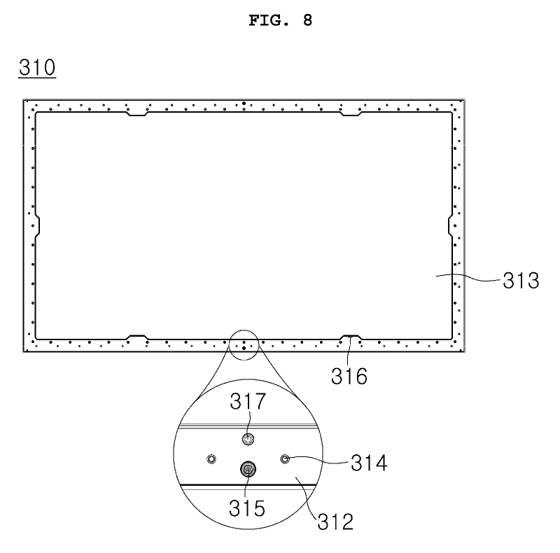

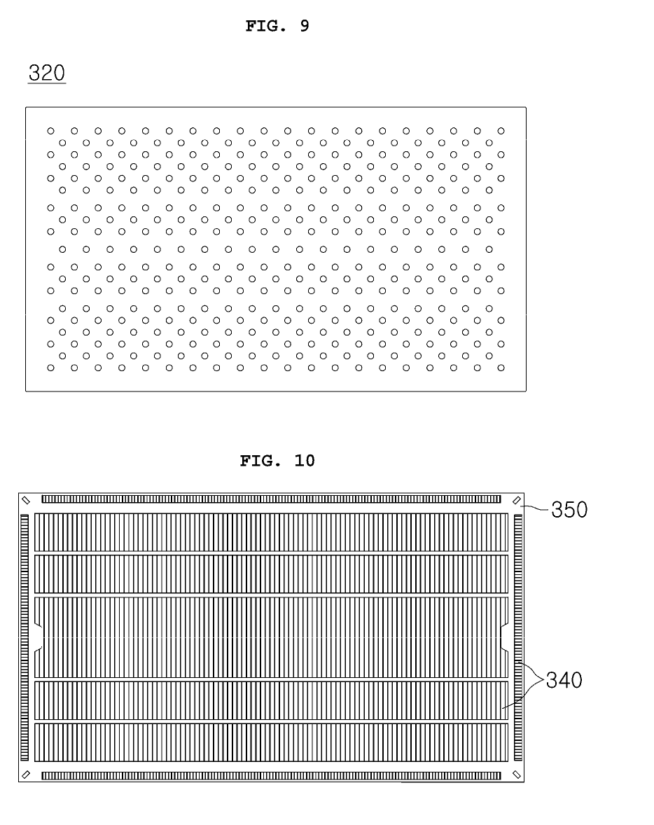

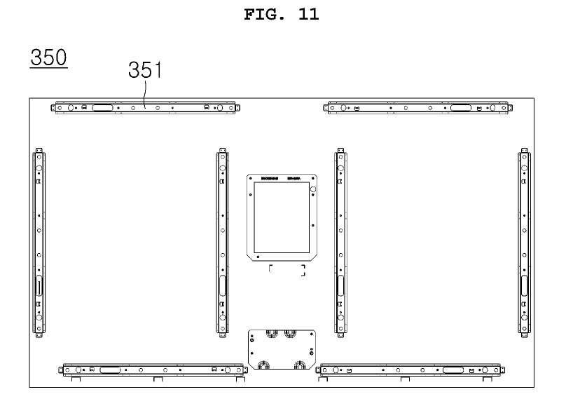

FIG. 6 is a perspective view illustrating the assembled state of the plate-type vacuum heat transfer apparatus of FIG. 5, FIG. 7 is an enlarged sectional view taken along line C-C of the plate-type vacuum heat transfer apparatus of FIG. 6, FIG. 8 is a plan view illustrating a first plate of FIG. 6, FIG. 9 is a plan view illustrating an inorganic sheet of FIG. 7, FIG. 10 is a plan view illustrating a second plate when a support frame of FIG. 7 is arranged, and FIG. 11 is a rear view illustrating the second plate of FIG. 7.

As illustrated in FIGS. 6 and 7, the plate-type vacuum heat transfer apparatus 300 of this embodiment has a plate-type container with a slim internal space. In this regard, the plate-type container is formed in one plate-type structure by overlapping two plates, namely, first and second plates 310 and 350 that are thin but large in area, and then welding outer edges thereof. As the welding method, argon welding, laser welding, and plasma welding may be used.

An inorganic sheet 320, a mesh member 330, and a support frame 340 are sequentially layered in the slim internal space of the plate-type container, and a small amount of heat transfer medium is inserted into the internal space in a vacuum state. That is, the inorganic sheet 320, the mesh member 330, the support frame 340 and the second plate 350 are sequentially layered on the first plate 310, and the small amount of heat transfer medium is inserted into the internal space in the vacuum state.

As illustrated in FIGS. 6 to 8, the first and second plates 310 and 350 come into contact with a heating element of an LED module and ambient air to transfer heat absorbed from the heating element and to emit the heat to the ambient air, and are made of a stainless steel material in a plate form. As the first and second plates 310 and 350 are made in the plate form, the contact area with the heating element is large and the contact area with the ambient air is also large, so that more efficient heat emission is possible. Preferably, the first and second plates 310 and 350 are made of an STS 304 material that possesses high strength and good corrosion resistance and heat emitting performance and has the thickness of 0.5 mm or less. As the first and second plates 310 and 350 are made of the stainless steel material, it is possible to improve rigidity.

As such, the slim internal space is defined in the plate-type container by the first and second plates 310 and 350. Such a slim internal space is obtained by making the first plate 310 in a stepped form and making the second plate 350 in a shape of a flat plate.

Here, the first plate 310 is formed such that an edge thereof is stepped upwards or downwards. That is, the first plate 310 includes a welding part 311 that is formed along the edge to be welded to the second plate 350, an LED module-mounting part 312 that forms a step of a predetermined height with the welding part 311 to provide a surface on which an LED module is to be mounted, and a light guide plate-mounting part 313 that forms a step of a predetermined height with the LED module-mounting part 312 to provide a surface on which a light guide plate is to be mounted.

The height of the steps for forming the LED module-mounting part 312 and the light guide plate-mounting part 313 is designed such that light radiated from an LED of the LED module secured to the LED module-mounting part 312 is precisely received by a light guide plate secured to the light guide plate-mounting part 313.

Preferably, the LED module-mounting part 312 further includes a plurality of fastening nuts 314 that are installed at equal intervals to fasten the LED module, a plurality of fastening pins 315 that fasten the light guide plate, and a plurality of connection-terminal mounting recesses 316 that are used to connect with the LED module. In this regard, the fastening nuts 314 and the fastening pins 315 may be formed on the LED module-mounting part 312 of the first plate 310 by welding or the like. Further, the connection-terminal mounting recesses 316 are indented inwards from the LED module-mounting part 312, and are formed in consideration of the first plate 310.

Preferably, the LED module-mounting part 312 further includes a plurality of depression preventing recesses 317 that are formed at equal intervals. Here, the depression preventing recesses 317 are depressed from a surface of the LED module-mounting part 312 to protrude towards the second plate 350. The depression preventing recesses are formed at positions where the LED module-mounting part 312 may be possibly deformed as a vacuum is applied thereto, regardless of whether the support frame 340 is installed under the LED module-mounting part 312. Thus, the plurality of depression preventing recesses 317 is formed in consideration of the first plate 310.

As illustrated in FIGS. 7 and 9, the inorganic sheet 320 is arranged such that a surface thereof is in close contact with an inner surface of the first plate 310 of the slim internal space. Thus, the heat transfer medium supplied to a portion of the internal space is pulled from a lower position to an upper position, so that it may be always condensed and evaporated in an entire area. The inorganic sheet 320 has a width sufficient to entirely cover a surface of the slim internal space. Such an inorganic sheet 320 should have high absorption for the heat transfer medium, chemical resistance for preventing it from reacting with the heat transfer medium, and a capillary force for pulling the heat transfer medium from the lower position to the upper position. Preferably, the inorganic sheet 320 has a plurality of holes to have a more efficient capillary force. In this embodiment, the reason why the inorganic sheet 320 is used is because the absorption and the capillary force for the heat transfer medium are excellent.

As such, the inorganic sheet 320 is arranged in the slim internal space of the plate-type container to pull the heat transfer medium from the lower position to the upper position and thereby always facilitate condensation and evaporation in the entire area. Thus, the plate-type vacuum heat transfer apparatus 300 of this embodiment allows the position of the heating element to be freely set due to the function of the inorganic sheet 320. For example, the heating element(s) may be located at one or several position(s) of the edge. As the heating element, the LED module or the like may be applied.

The mesh member 330 is arranged to be in close contact with a surface of the inorganic sheet 320, and serves to provide a passage allowing the heat transfer medium condensed in the condensation part to be smoothly moved along the inorganic sheet 320 towards the evaporation part. Therefore, the mesh member 330 is a mesh-net structure and is preferably made of an STS 304 material having high strength and good corrosion resistance.

As illustrated in FIGS. 7 and 10, the support frame 340 is arranged such that both surfaces thereof are in close contact with the inner surfaces of the mesh member 330 and the second plate 350, respectively, and function to support the first and second plates 310 and 350 and thereby prevent them from being deformed as a vacuum is applied to create the vacuum in the slim internal space of the plate-type container. Further, the support frame 340 provides a vapor passage to allow vapor evaporated in the evaporation part to flow towards the condensation part.

Therefore, the support frame 340 of this embodiment is made by bending a perforated plate in a zigzag fashion. The support frame 340 of this embodiment is made under the above-described concept. Various kinds of support frames 340 having different sizes (heights and widths) may be arranged at regular intervals. The support frames 340 are disposed such that a flow passage formed by bending is arranged in a vertical direction.

As illustrated in FIGS. 7 and 11, it is preferable that the second plate 350 further includes on an outer surface thereof a plurality of brackets 351 for the purpose of installing a closing cover or the like. Preferably, the plurality of brackets 351 is formed in various shapes and numbers depending on its purpose and function.

The heat transfer medium is inserted into a portion of the slim internal space of the plate-type container, absorbs heat generated from the evaporation part and then is evaporated. Thereby, the heat transfer medium exchanges heat with the entire area (condensation part) that is in contact with the ambient air, so that it emits heat, is condensed from a vapor phase to a liquid phase again and then is moved to the evaporation part. Therefore, the heat transfer medium preferably uses pure water satisfying the above-described conditions.

In the case of inserting the heat transfer medium into an air layer of the slim internal space, a perforation is formed in a side of the first plate 310, and the heat transfer medium is injected through the perforation. If the heat transfer medium is injected as such, the heat transfer medium is cooled, a vacuum is applied through the perforation, and then the perforation is sealed. Air cooling is performed at room temperature. As a result, an interior has a constant vacuum level.

The heat transfer mechanism of the plate-type vacuum heat transfer apparatus 300 of this embodiment configured as such is implemented such that the entire container may function to evaporate and condense a heat transfer medium, so that a part to which the heating element of the LED module is attached serves as an evaporation part and a remaining part serves as a condensation part. That is, if heat is introduced from the evaporation part, the interior has a vacuum state, so that the heat transfer medium is evaporated at 40° C. or less to be changed into the vapor phase, is moved upwards along the flow passage defined by the support frame 340, and exchanges heat with the entire area (condensation part) that is in contact with the ambient air, so that it emits heat and is condensed from the vapor phase to the liquid phase again. The condensed heat transfer medium is absorbed by the inorganic sheet 320. Meanwhile, after the heat transfer medium absorbed by the inorganic sheet 320 is moved towards the inorganic sheet 320 at which the evaporation part is located, heat is emitted to an outside by repeating the above-described process.

The plate-type vacuum heat transfer apparatus 300 of this embodiment is configured such that a vacuum is created in the state where the heat transfer medium is inserted into a portion of the slim internal space of the plate-type container. That is, as the internal space has the vacuum state, the heat transfer medium is repeatedly evaporated and condensed at low temperature, thus allowing the heat generated from the heating element to be more efficiently emitted.

Meanwhile, the plate-type vacuum heat transfer apparatus 300 of this embodiment may be configured such that each of the first and second plates 310 and 350 is made of an STS 304 material of 0.5 mm and has a thickness of 5 mm.

The outdoor plate-type vacuum heat transfer apparatus of this embodiment may be configured by assembling and integrating three plate-type vacuum heat transfer apparatuses 300 with each other using separate brackets. For example, the outdoor plate-type vacuum heat transfer apparatus of this embodiment may be configured by assembling three plate-type vacuum heat transfer apparatuses 300 with each other to have a size corresponding to a display area of 75 inches.

As such, as the outdoor plate-type vacuum heat transfer apparatus of this embodiment is configured by assembling the plurality of plate-type vacuum heat transfer apparatuses 300 having the above-described characteristics with each other, it is possible to more efficiently emit heat, the position of the heating element may be freely set, and a vertical configuration is possible. Further, the LED module and the light guide plate constituting the outdoor display device may be more ideally combined with each other by designing the shape of the first plate 310.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An outdoor plate-type vacuum heat transfer apparatus including a plurality of plate-type vacuum heat transfer apparatuses that are assembled to be integrated with each other, the plate-type vacuum heat transfer apparatus comprising:
a first plate and a second plate sealed to define an internal space in a vacuum state;
a heat transfer medium supplied to a portion of the internal space;
an inorganic sheet provided such that a first surface thereof is in close contact with an inner surface of the first plate in the internal space;
a mesh member coming into close contact with a second surface of the inorganic sheet; and
a support frame provided such that both surfaces thereof are in close contact with inner surfaces of the mesh member and the second plate, respectively, and defining a flow passage of the heat transfer medium,
wherein the first plate comprises:
a welding part formed along an edge and welded to the second plate;
an LED module-mounting part provided to form a step of a predetermined height with the welding part, thus defining an LED-module mounting surface; and
a light guide plate-mounting part provided to form a step of a predetermined height with the LED module-mounting part, thus defining a light guide plate-mounting surface.

2. The outdoor plate-type vacuum heat transfer apparatus as set forth in claim 1, wherein the LED module-mounting part further comprises a plurality of depression preventing recesses formed at equal intervals.

3. The outdoor plate-type vacuum heat transfer apparatus as set forth in claim 1, wherein the LED module-mounting part further comprises a plurality of fastening nuts installed at equal intervals to fasten the LED module.

4. The outdoor plate-type vacuum heat transfer apparatus as set forth in claim 1, wherein the LED module-mounting part further comprises a plurality of fastening pins to fasten a light guide plate.

5. The outdoor plate-type vacuum heat transfer apparatus as set forth in claim 1, wherein the LED module-mounting part further comprises a plurality of connection-terminal mounting recesses used to connect with the LED module.

6. The outdoor plate-type vacuum heat transfer apparatus as set forth in claim 1, wherein the support frame is made by bending a perforated plate.

7. The outdoor plate-type vacuum heat transfer apparatus as set forth in claim 1, wherein the inorganic sheet further comprises a plurality of holes.

8. The outdoor plate-type vacuum heat transfer apparatus as set forth in claim 1, wherein the second plate further comprises on an outer surface thereof a plurality of brackets to install a closing cover.

9. The outdoor plate-type vacuum heat transfer apparatus as set forth in claim 1, wherein three plate-type vacuum heat transfer apparatuses are assembled and integrated with each other using a separate bracket to have a size corresponding to a display area of 75 inches.
